(19) United States
(12) Patent Application Publication
(10) Pub. No.: US 2003/0156076 A1
(43) Pub. Date: Aug. 21, 2003

(54) Dynamic display updating system and the method of the same

(76) Inventor: Ronan Quinlan, Dublin (IE)

Correspondence Address: BIRCH STEWART KOLASCH & BIRCH, PO BOX 747, FALLS CHURCH, VA, 22040-0747, US

(21) Appl. No.: 10/076,272

(22) Filed: Feb. 19, 2002

(51) Int. Cl. G09G 5/00

(52) U.S. Cl. 345/2.1

(57) ABSTRACT

This specification discloses a dynamic display updating system and the method thereof. Using the invention, the controlling end of an electrical information product can update display contents dynamically for different controlled ends and make the display more efficient and convenient. The system contains a controlled end (including a controlled-end transceiver unit, a controlled-end CPU, and a display storage unit) and a controlling end (including a control-end transceiver, a control-end CPU, a display unit, a memory unit and a dynamic setting unit). The method includes the steps of: starting a controlling end and searching for a transceivable controlled end; performing dynamic settings from the controlling end, the controlling end performing settings and storage of display contents on the controlled end; transmitting the corresponding display contents from the controlled end to the controlling end for buffering; and the controlling end extracting the received corresponding display contents for dynamically updating the display.

### BACKGROUND OF THE INVENTION

1. Field of Invention

The present invention relates to a display updating system and the method for the same. In particular, the invention relates to a dynamic updating system and method used between a controlling end and a controlled end of an electrical information product for dynamically updating the display contents at the controlling end device through a common transceiving means.

2. Related Art

Electrical information products all contain some necessary basic.control devices. Taking the computer as an example, common control devices include such peripherals as keyboards, mice, and writing boards. Of course, other electrical information products may use their own specific control devices to manage their operations. Since different electrical information products have different orientations, applications and attributes, the required control devices also differ according to the functional purposes to which they are put to use. However, this situation naturally results in many disturbing problems. Of course, the first problem is that people have to learn how to use individual control devices, which may cause great obstacles and anxiety to the users and finally lose users' interest in the end product.

Besides, the control devices of normal electrical information products often have to be linked to the corresponding products and the electrical information products are incompatible with each other. This does not only increase the difficulty in product support but also causes incompatibility among the control devices. One result is that the user is less willing to use the products. When the user needs to simultaneously control several electrical information products, the limited compatibility and control functions of the respective control devices make the job fairly complicated and difficult.

Consequently, control devices that have high compatibility and can simultaneously support multiple electrical information product functions are becoming a trend on the market. Nevertheless, such universal control devices also face the challenging problem of display. The reason is that althrough they can control many different electrical information products, they have only a single display interface. That is, the display interface contents cannot be dynamically updated or adjusted for different control functions. Thus, it disrupts the practical use of controls in the user environment.

Therefore, it is highly desirable to provide a system and method that provides dynamic updating of the display interface contents to reduce the inherent constraints of use and obstacles in fixed display controls of different electrical information products. It is believed that such an advance can make the applications of electrical information products wider and more convenient.

There are universal remote controls for a limited number of electrical appliances on the market but these all need to be updated manually and involves a high degree of technical understanding on the part of the end user, therefore defeating the purpose of their function, which is supposed to simplify the user interaction with his/her surrounding electrical appliances.

### SUMMARY OF THE INVENTION

In view of the foregoing, the invention proposes a dynamic display updating system which can be automatic or manual, and the method of the same. A primary objective of the invention is to have the controlling end of an electrical information product perform a dynamic update of the display contents for different controlled ends. The invention can satisfy actual control requirements by different controlled ends of electrical information products.

To achieve the above objective, the disclosed dynamic display updating system is comprised of: a controlling end (including a controlled-end transceiver unit, a controlled-end CPU, and a disply storage unit) and a controlling end (including a control-end transceiver, a control-end CPU, a display unit, a memory unit and a dynamic setting unit). In effect the controlled and controlling ends can be switched around according to the display update function required.

Whatsmore, the disclosed dynamic display updating method includes the steps of: starting a controlling end and searching for a transceivable controlled end; performing dynamic settings from the controlling end, the controlling end performing settings and storage of display contents on the controlled end; transmitting the corresponding display contents from the controlled end to the controlling end for buffering; and the controlling end extracting the received corresponding display contents for dynamically updating the display.

### BRIEF DESCRIPTION OF THE DRAWINGS

The invention will become more fully understood from the detailed description given herein below are illustrations only, and thus are not limitative of the present invention, and wherein:

FIG. 1 shows a two-way setting updating structure of the disclosed dynamic display updating system;

FIG. 2 shows a one-way updating structure of the disclosed dynamic display updating system;

FIG. 3 shows a two-way setting updating flowchart of the disclosed dynamic display updating method; and

FIG. 4 shows a one-way updating flowchart of the disclosed dynamic display updating method.

### DETAILED DESCRIPTION OF THE INVENTION

The invention uses a common transceiving protocol to make the controlling end device of an electrical information product able to dynamically adjust display interface contents for different controlled end devices, satisfying actual control requirements by various types of electrical information products.

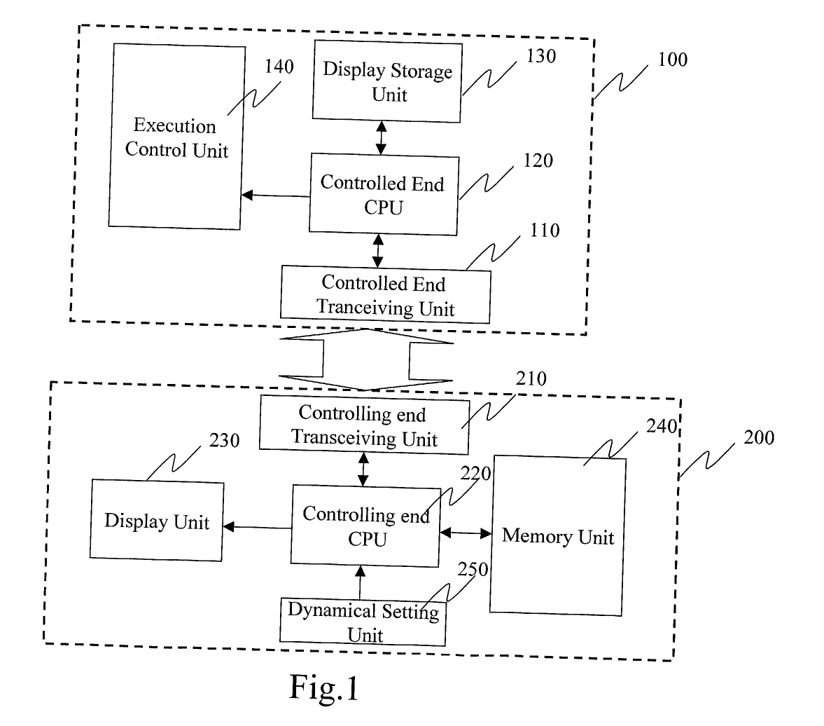

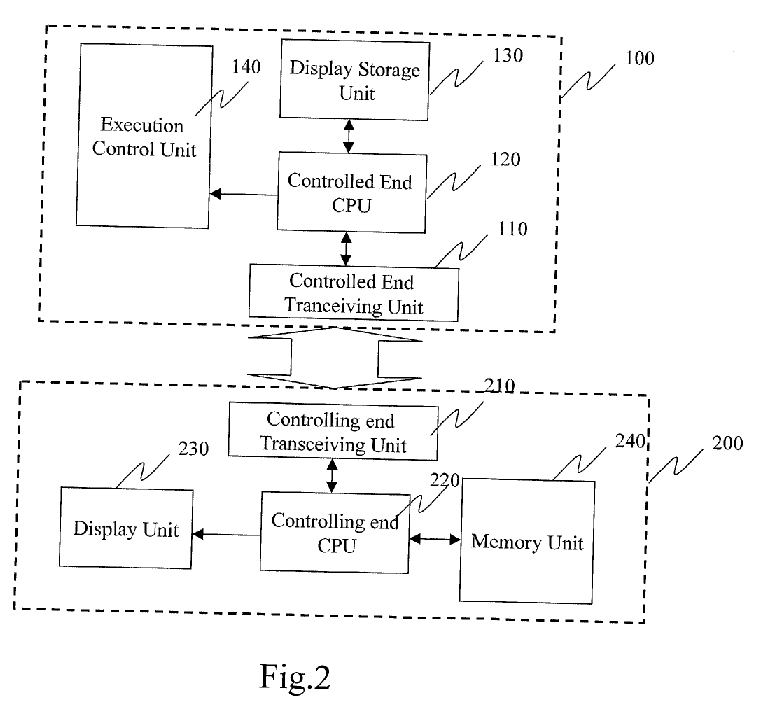

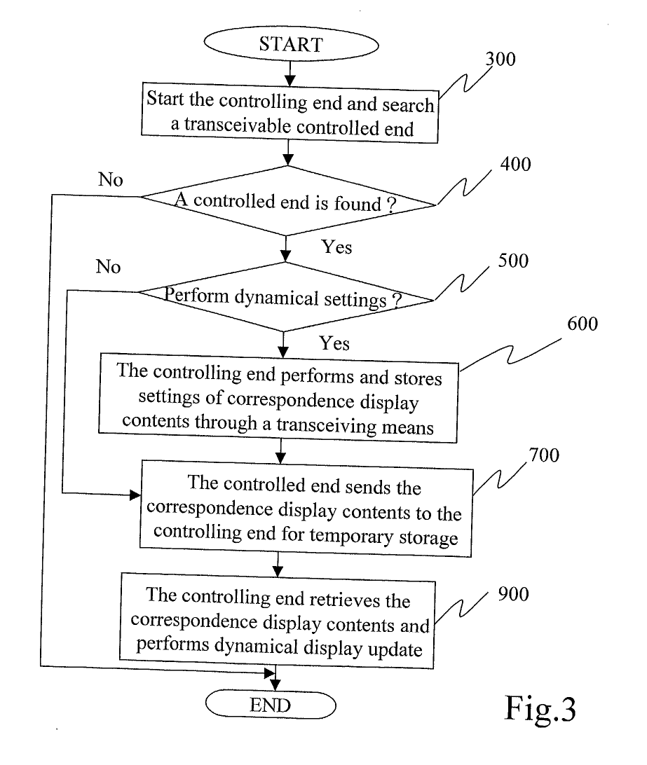

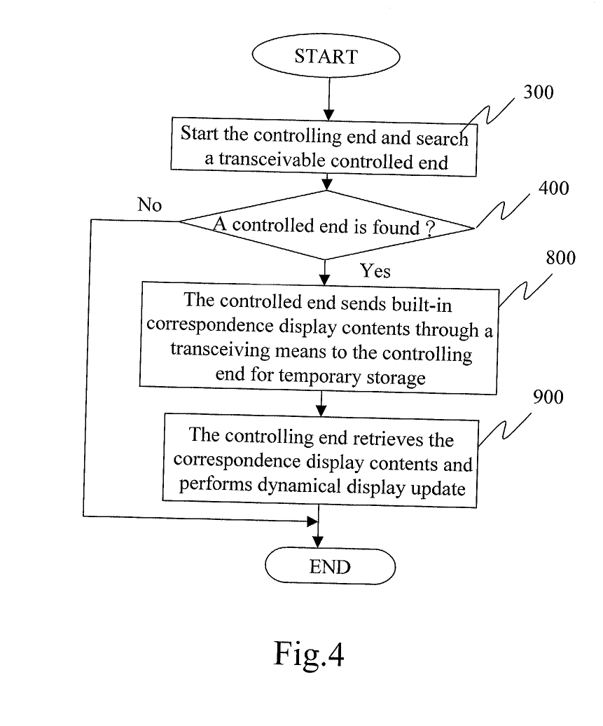

The invention can be implemented in two basic types: one is two-way, with both the setting and updating functions (see FIGS. 1 and 3); the other is one-way, with only the updating function (see FIGS. 2 and 4).

With reference to FIG. 1, the primary comprising units of the two-way updating system structure are as follows:

(1) The controlled end 100: It transmits and receives control signals and correspondence display contents set by a user. It further contains: (a) a controlled end transceiving unit 110, which transmits and receives the control signals and the correspondence display contents through a transceiving means;

(b) a controlled end CPU 120, which is in charge of connection controls during transmission and reception, processes storage, retrieval, transmission and reception of the correspondence display contents, and executing and controlling other functions; and (c) a display storage unit 130, which stores and provides the correspondence display contents.

(2) The controlling end 200: It transmits and receives control signals and correspondence display contents set by a user. It further contains: (a) a controlling end transceiving unit 210, which transmits and receives the control signals and the correspondence display contents through the transceiving means; (b) a controlling end CPU 220, which is in charge of connection controls during transmission and reception and processes storage, retrieval, transmission and reception of the correspondence display contents; (c) a display unit 230, which displays the correspondence display contents; (d) a memory unit 240, which temporarily stores and provides the correspondence display contents; and (e) a dynamic setting unit 250, which performs the settings of the correspondence display contents.

In this embodiment, the user can perform settings of the coresponding display contents on the controlled end 100 from the controlling end 200. After storing the correspondence display contents set by the user, the controlled end 100 can immediately return the setting to the controlling end 200 so that the controlling end 200 can complete the display content update. Through this embodiment, the user can arbitrarily choose preferred display content settings from the controlling end 200 no matter what kind of controlled end 100 it is.

In another embodiment, however, the one-way structure as shown in FIG. 2 has the following components:

(1) The controlled end 100: It transmits and receives control signals and transmits a built-in correspondence display contents. It further contains: (a) a controlled end transceiving unit 110, which transmits and receives the control signals and the correspondence display contents; (b) a controlled end CPU 120, which is in charge of connection controls during transmission and reception, processes storage, retrieval, transmission and reception of the correspondence display contents, and executing and controlling other functions; and (c) a display storage unit 130, which stores and provides the correspondence display contents.

(2) The controlling end 200: It transmits and receives control signals and correspondence display contents set by a user. It further contains: (a) a controlling end transceiving unit 210, which transmits and receives the control signals and the correspondence display contents; (b) a controlling end CPU 220, which is in charge of connection controls during transmission and reception and processes temporary storage, display and reception of the correspondence display contents; (c) a display unit 230, which displays the correspondence display contents; and (d) a memory unit 240, which temporarily stores and provides the correspondence display contents.

The structure of the current embodiment is roughly the same as the previous one. The difference is that in this embodiment the controlling end 200 does not have the function of dynamic display update. The dynamic display update is achieved using the built-in correspondence display contents in the controlled end 100. Therefore, the controlling end 200 does not have the dynamic setting unit 250 as in the previous case. The dynamic display updating contents are purely determined by the controlled end 100 coupled to the controlling end 200.

A practical result of the invention is that both the controlled end 100 and the controlling end 200 adopt a common transceiving method. Such a method can be wired transmission/reception using, for example, USB interfaces, PS/2 interfaces, game port interfaces, etc; or wireless transmission/reception using, for example, the Bluetooth technology, IR (Infrared Radio) communications, home RF (Radio Frequency) networking, IEEE802.11A, IEEE802.11B, WAP (Wireless Application Protocol), and GPRS (General Packet Radio Service).

With reference to FIG. 3, the operation of the disclosed two-way setting update is detailed as follows:

First, the user or an event satisfying certain predefined criteria starts a controlling end 200, which begins to search a controlled end 100 using the same transmission/reception protocol (step 300). The system at the controlling end 200 determines whether the desired controlled end 100 is found (step 400). If the controlling end 200 cannot find the controlled end 100 using the same tranceiving protocol, the procedure stops. If it is found, the system at the controlling end 200 asks the user whether to perform dynamic settings on the controlled end 100 from the controlling end 200 (step 500). If the controlling end 200 is to perform dynamic settings on the controlled end 100, then the controlling end 200 sends out a control signal to the controlled end 100 and starts to display correspondence content settings. All the changed display contents set by the user are stored in the controlled end 100 (step 600). The controlled end 100 transfers all the corresponding display contents changes to the controlling end 200 for storage (step 700). When the controlling end 200 receives the correspondence display contents changes sent from the controlled end 100, the contents are immediately extracted for dynamic display update (step 900). In summary, the user has performed the correspondence display contents update on the controlled end 100, consequently the display contents at the controlling end 200 are dynamically updated through the transmissions of the controlled end 100. This completes the procedure of the method.

Finally, please refer to FIG. 4 for an embodiment of the one-way updating method. Analogous to the previous embodiment, a user first starts a controlling end 200. The system at the controlling end 200 determines whether the desired controlled end 100 is found (step 400). If the controlling end 200 cannot find the controlled end 100 using the same tranceiving protocol, the procedure stops. If it is found, the controlled end 100 transmits built-in correspondence display contents to the controlling end 200 following a predetermined transmission/reception method for the controlling end 200 to store (step 800). After the controlling end 200 completes the action of temporarily storing the correspondence display contents, the display contents can be immediately extracted for dynamic display updating (step 900). This then completes the one-way updating operation.

In practice, the display part of the dynamic display updating system and method disclosed herein can be implemented using an LCD (Liquid Crystal Display), TFT(Thin Film Transistor) display or any electronically powered display. Therefore, the display contents can be more versatile than traditional printing of text or graphics to include stationary or moving texts, numbers, pictures and video images. The display mode can be color or black-and-white, depending upon the electrical information product. In practice, the invention can provide both two-way settings update and the one-way update. Therefore, even different categories of electrical information products of can achieve the goal of dynamic display update by sharing the common transceiving protocol. For example, the two-way settings updating method can be applied to a computer (controlled end 100) and a keyboard (a controlling end 200). Using the invention, a user can input the preferred display content settings for the keyboard, using the keyboard. The setting contents are sent to the computer for storage and subsequent use. Once the contents are stored, the computer sends the correspondence display contents set by the user back to the keyboard and the display contents on the keyboard are updated to those set by the user. Moreover, the disclosed one-way updating method can be applied to normal portable electronic devices (controlling end 200) such as PDA's (Personal Digital Assistant) and mobile phones. When the portable electronic device carried by the user approaches within a set distance of another electrical information device (controlling end 100), such as an ATM (Automated Teller Machine), or a vending machine, the ATM or vending machine will automatically transmit built-in display contents to the user's portable electronic device to make it suitable to perform some operation on the said device. The original display contents are then dynamically updated for subsequent uses and operations by the user.

### EFFECTS OF THE INVENTION

The disclosed dynamic display updating system and method make the controlling end of an electrical information product dynamically generate display contents for different controlled ends by using a common transmission/reception protocol. The invention does not only reduce the difficulty in practical use of devices, but also increases the efficiency of operating any electric appliance.

Furthermore, the invention greatly simplifies the design of many control devices in the past, making them more compatible with other electrical information products. Therefore, users will be more willing to accept the uses of all kinds of electrical information products. New functionality can be added to the controlling end device to extend it's range of use and product life.

Manufacturers or retailers can update their products remotely to alter the end users input buttons display automatically and consequently change and upgrade the functionality of the product. If a manufacturer has leftover inventory of computer keyboards with Spanish language for example, by updating the display of the keyboard these keyboards can be transformed to English language and sold elsewhere. Keyboards with special one button “hotkey” macro features are available on the market and have a software function change feature. For example for a given keyboard the default setting of “WWW” can be changed to the “Access Email” button for the keyboard using a software menu. The function change can be noted in a title change on the software screen. But conventional printed keyboards cannot show this update on the keyboard itself as the default title is printed “WWW”. The end user can easily forget that the “WWW” button now opens “Access Email” so current hotkey functionality ease of use is severely restricted to the default settings.

On the other hand, with dynamic display updating any updates to the software hotkey title will automatically update the keyboard hotkey title displayed, so the enduser will never be confused. For the previous example quoted above, this means that “WWW” display will now display “Access Email” on both the computer screen and on the keyboard itself.

An old model of mobile phone can be updated to show new functionality by altering the display of the buttons on the phone by the service provider.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A dynamic display updating system for a controlled electrical information product and a controlling electrical information product sharing a common and compatible transmission/reception method to perform immediate two-way settings and updates so that the display contents on the controlling electrical information product are dynamically updated, the system comprising:
a controlled end, which transmits/receives a control signal and correspondence display contents set by the user and further includes:
a controlled end transceiving unit for transmitting and receiving the control signal and the correspondence display contents using the transmission/reception method;
a controlled end CPU (Central Processing Unit) for connection controls during the transmission and reception and processing the storage, retrieval, transmission and reception of the correspondence display contents; and
a display storage unit for storing and providing the correspondence display contents; and
a controlling end, which transmits and receives the control signal, receives the correspondence display contents set by the user, and further includes:
a controlling end transceiving unit for transmitting and receiving the control signal and the correspondence display contents using the transmission/reception method;
a controlling end CPU for connection controls during the transmission and reception and processing the storage, retrieval, transmission and reception of the correspondence display contents;
a display unit for displaying the correspondence display contents;
a memory unit for temporarily storing and providing the correspondence display contents; and
a dynamic setting unit for setting the correspondence display contents.

2. The system of claim 1, wherein the controlled end further contains an execution control unit that couples to the controlled end CPU and performs correspondence execution and controls according to the control signal.

3. The system of claim 1, wherein the transmission/reception method includes a wired transmission/reception method and a wireless transmission/reception method.

4. The system of claim 3, wherein the wired transmission/reception method is performed using one from the group consisting of USB interfaces, PS/2 interfaces and game port interfaces.

5. The system of claim 3, wherein the wireless transmission/reception method is selected from the group consisting of the Bluetooth technology, IR (Infrared Radio) communications, home RF (Radio Frequency) networking, IEEE802.11A, IEEE802.11B, WAP (Wireless Application Protocol), and GPRS (General Packet Radio Service).

6. The system of claim 1, wherein the display contents on the display unit include texts, numbers, pictures and video images.

7. A dynamic display updating method for a controlled electrical information product and a controlling electrical information product sharing a common and compatible transmission/reception method to perform immediate two-way settings and updates so that the display contents on the controlling electrical information product are dynamically updated, the method comprising the steps of:
starting the controlling end and searching for a transceivable controlled end;
performing dynamic settings;
the controlling end performing correspondence display contents settings on the controlled end using the transmission/reception method and storing the correspondence display contents settings;
the controlled end transferring the correspondence display contents to the controlling end for temporary storage; and
the controlling end extracting the correspondence display contents and performing dynamic display updates.

8. The method of claim 7, wherein the transmission/reception method includes a wired transmission/reception method and a wireless transmission/reception method.

9. The method of claim 8, wherein the wired transmission/reception method is performed using one from the group consisting of USB interfaces, PS/2 interfaces and game port interfaces.

10. The method of claim 8, wherein the wireless transmission/reception method is selected from the group consisting of the Bluetooth technology, IR (Infrared Radio) communications, home RF (Radio Frequency) networking, IEEE802.11A, IEEE802.11B, WAP (Wireless Application Protocol), and GPRS (General Packet Radio Service).

11. The method of claim 7, wherein the display contents on the display unit include texts, numbers, pictures and video images.

12. A dynamic display updating system for a controlled electrical information product and a controlling electrical information product sharing a common and compatible transmission/reception method to perform immediate one-way settings and updates so that the display contents on the controlling electrical information product are dynamically updated, the system comprising:
a controlled end, which transmits/receives a control signal and correspondence display contents set by the user and further includes:
a controlled end transceiving unit for transmitting and receiving the control signal and the correspondence display contents using the transmission/reception method;
a controlled end CPU (Central Processing Unit) for connection controls during the transmission and reception and processing the storage, retrieval, transmission and reception of the correspondence display contents; and
a display storage unit for storing and providing the correspondence display contents; and
a controlling end, which transmits and receives the control signal, receives the correspondence display contents set by the user, and further includes:
a controlling end transceiving unit for transmitting and receiving the control signal and the correspondence display contents using the transmission/reception method;
a controlling end CPU for connection controls during the transmission and reception and processing the storage, retrieval, transmission and reception of the correspondence display contents;
a display unit for display the correspondence display contents; and
a memory unit for temporarily storing and providing the correspondence display contents.

13. The system of claim 12, wherein the controlled end further contains an execution control unit that couples to the controlled end CPU and performs correspondence execution and controls according to the control signal.

14. The system of claim 12, wherein the transmission/reception method includes a wired transmission/reception method and a wireless transmission/reception method.

15. The system of claim 14, wherein the wired transmission/reception method is performed using one from the group consisting of USB interfaces, PS/2 interfaces and game port interfaces.

16. The system of claim 14, wherein the wireless transmission/reception method is selected from the group consisting of the Bluetooth technology, IR (Infrared Radio) communications, home RF (Radio Frequency) networking, IEEE802.11A, IEEE802.11B, WAP (Wireless Application Protocol), and GPRS (General Packet Radio Service).

17. A dynamic display updating method for a controlled electrical information product and a controlling electrical information product sharing a common and compatible transmission/reception method to perform immediate one-way settings and updates so that the display contents on the controlling electrical information product are dynamically updated, the method comprising the steps of:
starting the controlling end and searching for a transceivable controlled end;
the controlled end transferring built-in correspondence display contents to the controlling end for temporary storage; and
the controlling end extracting the correspondence display contents and performing dynamic display updates.

18. The method of claim 17, wherein the transmission/reception method includes a wired transmission/reception method and a wireless transmission/reception method.

19. The method of claim 18, wherein the wired transmission/reception method is performed using one from the group consisting of USB interfaces, PS/2 interfaces and game port interfaces.

20. The method of claim 18, wherein the wireless transmission/reception method is selected from the group consisting of the Bluetooth technology, IR (Infrared Radio) communications, home RF (Radio Frequency) networking, IEEE802.11A, IEEE802.11B, WAP (Wireless Application Protocol), and GPRS (General Packet Radio Service).
